(19) United States
(12) Patent Application Publication
(10) Pub. No.: US 2023/0128447 A1
(43) Pub. Date: Apr. 27, 2023

(54) PIGGYBACKING CHANNEL STATE INFORMATION ON SIDELINK SHARED CHANNEL

(71) Applicant: QUALCOMM Incorporated, San Diego, CA (US)

(72) Inventors: Ahmed ELSHAFIE, San Diego, CA (US); Wei YANG, San Diego, CA (US); Seyedkianoush HOSSEINI, San Diego, CA (US)

(21) Appl. No.: 17/451,732

(22) Filed: Oct. 21, 2021

(51) Int. Cl. H04W 72/08; H04W 72/04; H04L 5/00

(52) U.S. Cl. CPC H04W 72/085; H04W 72/0406; H04L 5/0051; H04L 5/0053

(57) ABSTRACT

Various aspects of the present disclosure generally relate to wireless communication. In some aspects, a receiver user equipment (UE) may receive, from a transmitter UE, a sidelink communication. The receiver UE may transmit, to the transmitter UE, based at least in part on receiving the sidelink communication, channel state information (CSI) using one or more resources of a physical sidelink shared channel (PSSCH). Numerous other aspects are described.

### FIELD OF THE DISCLOSURE

Aspects of the present disclosure generally relate to wireless communication and to techniques and apparatuses for piggybacking channel state information on a sidelink shared channel.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a receiver user equipment (UE). The method may include receiving, from a transmitter UE, a sidelink communication. The method may include transmitting, to the transmitter UE, based at least in part on receiving the sidelink communication, channel state information (CSI) using one or more resources of a physical sidelink shared channel (PSSCH).

Some aspects described herein relate to a method of wireless communication performed by a transmitter UE. The method may include transmitting, to a receiver UE, a sidelink communication. The method may include receiving, from the receiver UE, based at least in part on transmitting the sidelink communication, CSI using one or more resources of a PSSCH.

Some aspects described herein relate to an apparatus for wireless communication performed by a receiver UE. The apparatus may include a memory and one or more processors, coupled to the memory. The one or more processors may be configured to receive, from a transmitter UE, a sidelink communication. The one or more processors may be configured to transmit, to the transmitter UE, based at least in part on receiving the sidelink communication, CSI using one or more resources of a PSSCH.

Some aspects described herein relate to an apparatus for wireless communication performed by transmitter UE. The apparatus may include a memory and one or more processors, coupled to the memory. The one or more processors may be configured to transmit, to a receiver UE, a sidelink communication. The one or more processors may be configured to receive, from the receiver UE, based at least in part on transmitting the sidelink communication, CSI using one or more resources of a PSSCH.

Some aspects described herein relate to a non-transitory computer-readable medium that stores a set of instructions for wireless communication by a receiver UE. The set of instructions, when executed by one or more processors of the UE, may cause the UE to receive, from a transmitter UE, a sidelink communication. The set of instructions, when executed by one or more processors of the UE, may cause the UE to transmit, to the transmitter UE, based at least in part on receiving the sidelink communication, CSI using one or more resources of a PSSCH.

Some aspects described herein relate to a non-transitory computer-readable medium that stores a set of instructions for wireless communication by a transmitter UE. The set of instructions, when executed by one or more processors of the UE, may cause the UE to transmit, to a receiver UE, a sidelink communication. The set of instructions, when executed by one or more processors of the UE, may cause the UE to receive, from the receiver UE, based at least in part on transmitting the sidelink communication, CSI using one or more resources of a PSSCH.

Some aspects described herein relate to an apparatus for wireless communication. The apparatus may include means for receiving, from a transmitter UE, a sidelink communication. The apparatus may include means for transmitting, to the transmitter UE, based at least in part on receiving the sidelink communication, CSI using one or more resources of a PSSCH.

Some aspects described herein relate to an apparatus for wireless communication. The apparatus may include means for transmitting, to a receiver UE, a sidelink communication. The apparatus may include means for receiving, from the receiver UE, based at least in part on transmitting the sidelink communication, CSI using one or more resources of a PSSCH.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of feedback in sidelink communications, in accordance with the present disclosure.

FIG. 6 is a diagram illustrating an example associated with piggybacking channel state information on a sidelink shared channel, in accordance with the present disclosure.

FIG. 7 is a diagram illustrating an example process associated with piggybacking channel state information on a sidelink shared channel, in accordance with the present disclosure.

FIG. 8 is a diagram illustrating an example process associated with piggybacking channel state information on a sidelink shared channel, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

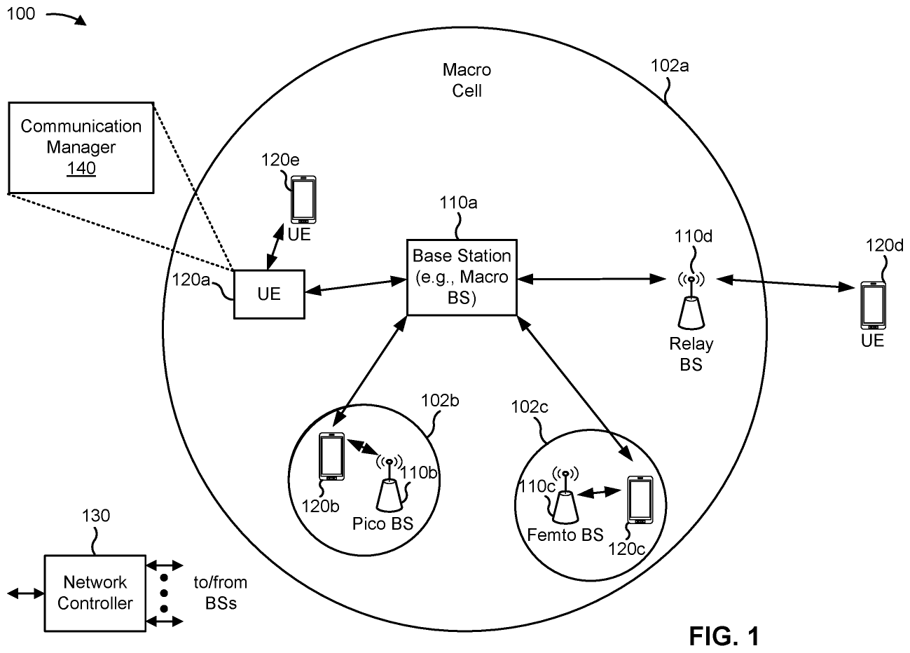

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a transmitter UE, a sidelink communication; and transmit, to the transmitter UE, based at least in part on receiving the sidelink communication, CSI using one or more resources of a PSSCH. Additionally, or alternatively, the communication manager 140 may perform one or more other operations described herein.

In some aspects, the UE 120 may include a communication manager 140. As described in more detail elsewhere herein, the communication manager 140 may transmit, to a receiver UE, a sidelink communication; and receive, from the receiver UE, based at least in part on transmitting the sidelink communication, CSI using one or more resources of a PSSCH. Additionally, or alternatively, the communication manager 140 may perform one or more other operations described herein.

As indicated above, FIG. 1 is provided as an example. Other examples may differ from what is described with regard to FIG. 1.

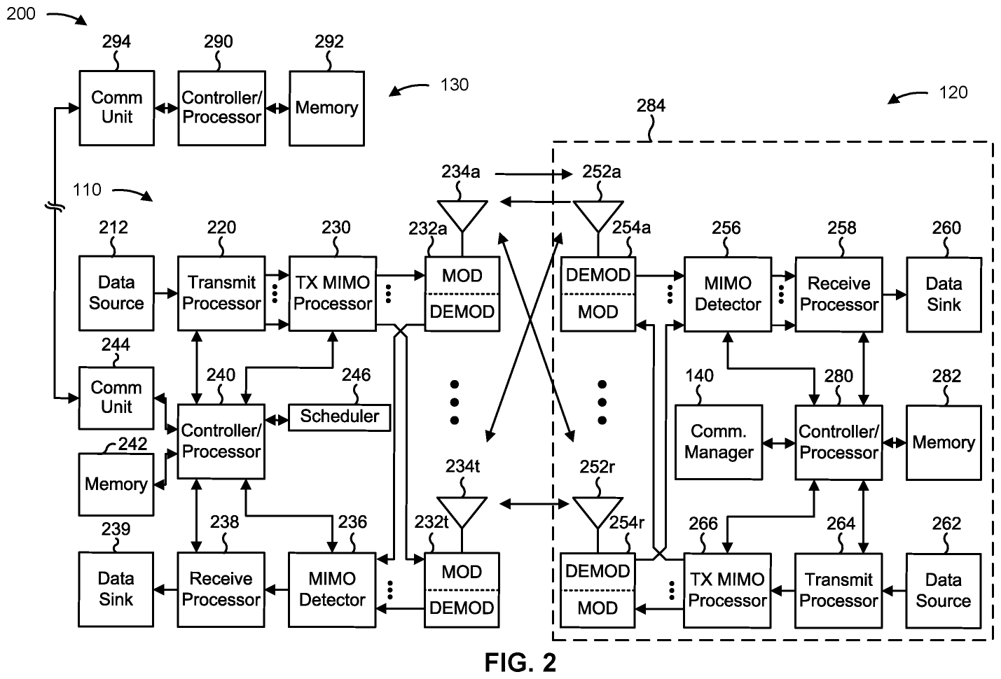

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

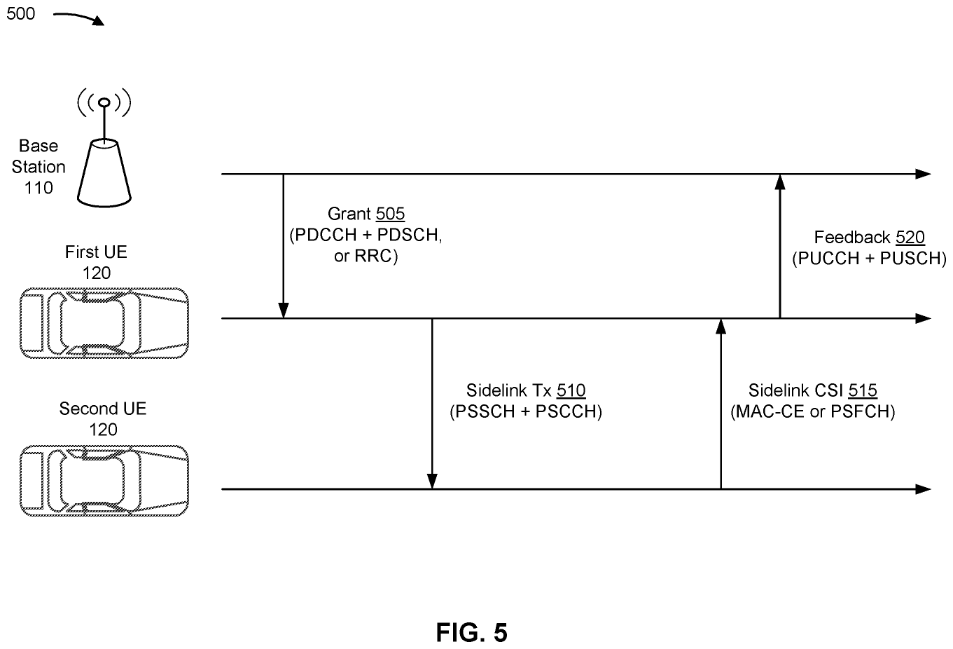

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

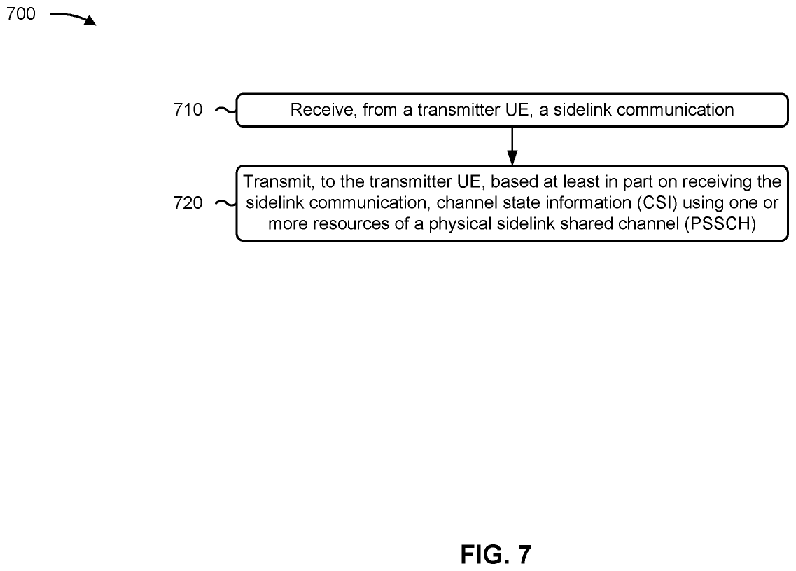

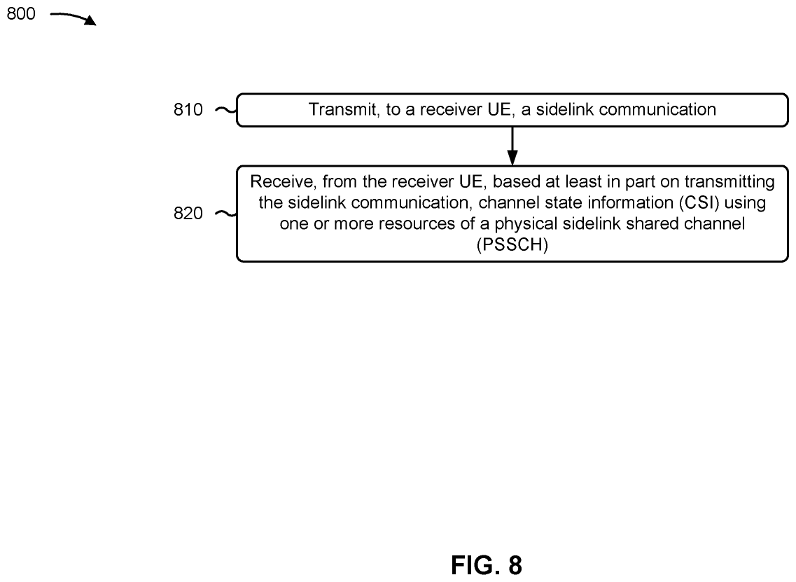

The controller/processor 240 of the base station 110, the controller/processor 280 of the UE 120, and/or any other component(s) of FIG. 2 may perform one or more techniques associated with piggybacking channel state information on a sidelink shared channel, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the receiver UE includes means for receiving, from a transmitter UE, a sidelink communication; and/or means for transmitting, to the transmitter UE, based at least in part on receiving the sidelink communication, CSI using one or more resources of a PSSCH. The means for the receiver UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the transmitter UE includes means for transmitting, to a receiver UE, a sidelink communication; and/or means for receiving, from the receiver UE, based at least in part on transmitting the sidelink communication, CSI using one or more resources of a PSSCH. The means for the transmitter UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

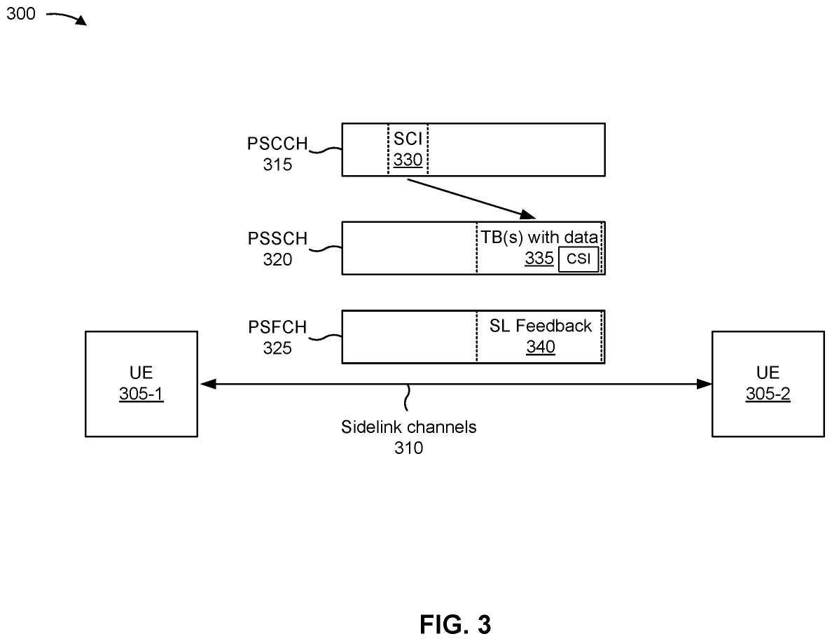

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a base station 110. For example, the UE 305 may receive a grant (e.g., in downlink control information (DCI) or in a radio resource control (RRC) message, such as for configured grants) from the base station 110 for sidelink channel access and/or scheduling. In some aspects, a UE 305 may operate using a transmission mode (e.g., Mode 2) where resource selection and/or scheduling is performed by the UE 305 (e.g., rather than a base station 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As described further herein, the UE 120 may be configured to receive a sidelink communication, and to transmit CSI using one or more resources of the PSSCH. For example, the UE 120 may be configured to transmit the CSI using a sidelink shared channel (SL-SCH) of the PSSCH or using resources of the PSSCH (e.g., the CSI may be multiplexed with data of an SL-SCH).

As indicated above, FIG. 3 is provided as an example. Other examples may differ from what is described with respect to FIG. 3.

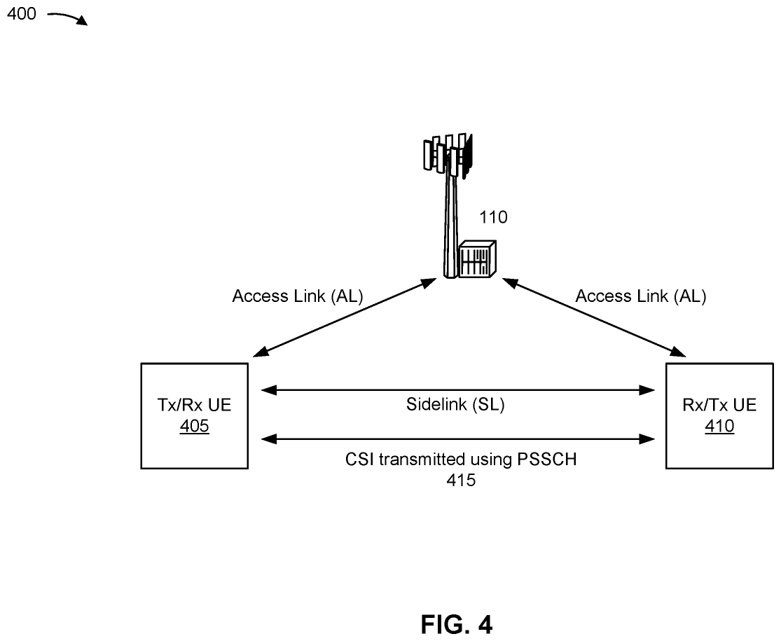

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

In some aspects, the Tx/Rx UE 405 may transmit CSI to the Tx/Rx UE 410 based at least in part on the sidelink communication from the Tx/Rx UE 410 to the Tx/Rx UE 405 (e.g., based at least in part on one or more reference signals). Additionally, or alternatively, the Tx/Rx UE 410 may transmit CSI to the Tx/Rx UE 405 based at least in part on the sidelink communication from the Tx/Rx UE 405 to the Tx/Rx UE 410 (e.g., based at least in part on one or more reference signals).

As indicated above, FIG. 4 is provided as an example. Other examples may differ from what is described with respect to FIG. 4.

FIG. 5 is a diagram illustrating an example 500 of feedback in sidelink communications, in accordance with the present disclosure.

As shown in FIG. 5, a base station, such as the base station 110, and one or more UEs, such as a first UE 120 and a second UE 120, may communicate using the PDCCH and the PDSCH for a downlink communication, and may communicate using the PUCCH and the PUSCH for an uplink communication. The first UE 120 and the second UE 120 may communicate on the sidelink using the PSSCH and the PSCCH. The first UE 120 and the second UE 120 may communicate CSI associated with a sidelink communication using the PSFCH. While FIG. 5 shows the base station 110 communicating with the first UE 120 and the second UE 120, the base station 110 may be configured to communicate with any number of UEs 120 using the PDCCH, PDSCH, PUCCH, and/or PUSCH, and any number of UEs may be configured to communicate with any number of other UEs using the PSSCH, PSCCH, and/or PSFCH.

In some cases, the first UE 120 may determine one or more characteristics of a channel based at least in part on CSI received from the second UE 120. The CSI may be based at least in part on one or more resources (e.g., time resources, frequency resources, and/or spatial resources) of the PSSCH. In some aspects, the CSI may be based at least in part on a CSI reference signal (CSI-RS). In some cases, the second UE 120 may transmit a CSI report identifying the CSI, such as a periodic CSI report or an aperiodic CSI report. A periodic CSI report may include CSI reported by the UE 120 periodically (e.g., according to a reporting period) based at least in part on a configuration by a higher layer, for example, using an RRC message. An aperiodic CSI report may include CSI reported by the UE 120 based at least in part on one or more conditions, such as based in least in part on receiving DCI that triggers the aperiodic CSI report.

As described above, the PSCCH may carry SCI, which may indicate control information used for sidelink communications, such as one or more resources (e.g., time resources, frequency resources, and/or spatial resources) where a TB may be carried on the PSSCH. The SCI may include various stages of control information. For example, SCI-1 may indicate priority information (e.g., QoS values), a PSSCH resource assignment (e.g., frequency/time resources for the PSSCH), a resource reservation period, and/or a PSSCH DMRS pattern, among other examples. The SCI-1 may include information associated with the SCI-2. For example, the SCI-1 may indicate a location in the SCI-2 where certain information, such as the CSI, is located. In some cases, SCI-2 may indicate a HARQ process ID, an NDI, a source ID, a destination ID, and/or a CSI report trigger, among other examples. The SCI-2 may include information associated with another stage of control information, such as third stage SCI (SCI-3). For example, the SCI-2 may indicate a location in the SCI-3 where certain information, such as the CSI, is located. As described, each stage of SCI (e.g., SCI-(X)) may include information that points to a location in the next stage of SCI (e.g., SCI-(X+1)) where certain information (e.g., CSI) is located.

As shown in the example of FIG. 5, in some examples, the base station 110 may transmit a grant 505 to the first UE 120 using a PDCCH communication and/or a PDSCH communication, or using RRC signaling. The first UE 120 may transmit a sidelink communication 510 to the second UE 120 based at least in part on the grant received from the base station 110. The sidelink communication may include a PSSCH communication, a PSCCH communication, or a CSI-RS. The second UE 120 may transmit sidelink feedback 515 (e.g., sidelink CSI) to the first UE 120 (as described below) based at least in part on receiving the sidelink communication. The first UE 120 may transmit the CSI 520 to the base station 110 using a PUCCH communication and/or a PUSCH communication.

In a first example, the second UE 120 may transmit the CSI to the first UE 120 using a medium access control (MAC) control element (CE) (MAC-CE). However, the MAC-CE is a relatively slow mechanism for the first UE 120 to receive the CSI and to transmit a communication based at least in part on the CSI. For example, a communication using the MAC-CE is a Layer 2 (L2) communication that may require a mapping between logical channels and transport channels, or may involve processing in Layer 2. This may result in delays in the transmission of the communication by the first UE 120.

In a second example, the second UE 120 may transmit the CSI using the PSFCH. The transmission using the PSFCH may be a Layer 1 (L1) communication, and thus, the transmission of the CSI using the PSFCH may enable the first UE 120 to receive the CSI in a relatively short time period relative to transmission via MAC signaling. However, transmissions using the PSFCH may not be as reliable as transmissions using the MAC-CE. Additionally, the CSI computation might be multiplexed across multiple transmitter UEs communicating with the same receiver UE, which may require a larger resource allocation for transmission of the CSI than is provided by the PSFCH.

Techniques and apparatuses described herein enable the CSI to be transmitted using one or more resources of the PSSCH. In some examples, the CSI may be determined and/or transmitted without Layer 2 processing (e.g., without inclusion in a MAC-CE for transmission via the PSSCH). A receiver UE may receive a sidelink communication from a transmitter UE, and may determine CSI based at least in part on the sidelink communication. The receiver UE may transmit, to the transmitter UE, the CSI using the one or more resources of the PSSCH. For example, the CSI may be transmitted (e.g., piggybacked) in or with a transport channel (e.g., the SL-SCH) of the PSSCH. In some aspects, the CSI may be encoded in the PSSCH with other information, such as SCI-2, SCI-3, or other data being transmitted in the PSSCH. Although the PSSCH is intended for data transmissions, and transmitting CSI on the PSSCH results in less bandwidth for such data transmissions, the PSSCH may provide a fast and reliable channel that is not currently available for devices to communicate sidelink CSI, without using significant resources of the PSSCH that are otherwise used for data transmissions. The CSI may include a group identifier that identifies one or more other UEs, such as a second transmitter UE. The transmitter UE, based at least in part on receiving the group identifier, may transmit (e.g., relay) the CSI to the one or more other UEs using one or more resources of the PSSCH.

As described above, transmitting the CSI using the MAC-CE may result in delayed communications, for example, since the transmission of the CSI using the MAC-CE is a L2 communication. In contrast, transmitting the CSI using the PSFCH may result in faster communications, since the transmission of the CSI using the PSFCH is a L1 communication. However, transmissions using the PSFCH may not be as reliable as transmissions using the MAC-CE, and may require a larger resource allocation than the resource allocation provided by the PSFCH. The techniques and apparatuses described herein enable the CSI to be transmitted in one or more resources of the PSSCH, such as in the SL-SCH of the PSSCH. Transmitting the CSI in the one or more resources of the PSSCH may enable faster transmissions of the CSI, while providing improved reliability and a larger resource allocation relative to the PSFCH.

As indicated above, FIG. 5 is provided as an example. Other examples may differ from what is described with respect to FIG. 5.

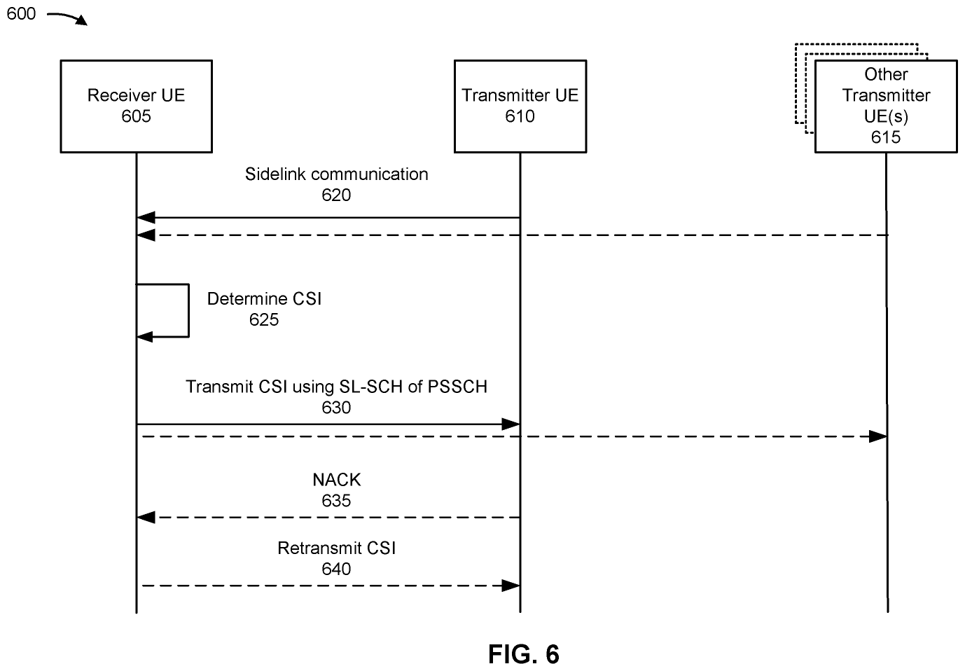

FIG. 6 is a diagram illustrating an example 600 of piggybacking channel state information on a sidelink shared channel, in accordance with the present disclosure. As shown in FIG. 6, example 600 may include a receiver UE 605, a transmitter UE 610, and one or more other transmitter UEs 615. While the UE 605 and the UE 610 are respectively referred to as the receiver UE 605 and the transmitter UE 610, both the receiver UE 605 and the transmitter UE 610 may be configured to receive and transmit data. For example, the receiver UE 605 and the transmitter UE 610 may be configured with some or all of the features of the UE 120 described above. The one or more transmitter UEs 615 may include any number of transmitter UEs, including but not limited to the second transmitter UE 615 and the third transmitter UE 615 described below.

As shown in connection with reference number 620, the transmitter UE 610 may transmit, and the receiver UE 605 may receive, a sidelink communication. The sidelink communication may be transmitted using one or more transport channels, such as using one or more resources of the PSSCH, or using MAC layer signaling (e.g., a MAC-CE).

In some aspects, one or more other transmitter UEs 615 may transmit, and the receiver UE 605 may receive, a sidelink communication. For example, a second transmitter UE 615 may transmit, and the receiver UE 605 may receive, a second sidelink communication. The second sidelink communication may be transmitted using one or more resources of the PSSCH. In some aspects, the second sidelink communication may be transmitted using a second PSSCH resource that is different from the PSCCH resource on which a first sidelink communication is transmitted, such as the sidelink communication described above as being transmitted by the transmitter UE 610. As described above, the other transmitter UEs 615 may include any number of UEs, such as the second transmitter UE 615 and a third transmitter UE 615, among other examples. In some aspects, the receiver UE 605 may receive separate transmissions from each of a plurality of other UEs 615, and may transmit CSI to the plurality of other UEs using a groupcast communication, as described further below.

As shown in connection with reference number 625, the receiver UE 605 may determine CSI. The CSI may be determined based at least in part on the sidelink communication. In some aspects, the sidelink communication may include a reference signal, such as a CSI reference signal or a reference signal associated with the PSSCH. The receiver UE 605 may generate the CSI based at least in part on the reference signal, such as based at least in part on the CSI reference signal or based at least in part on the reference signal associated with the PSSCH. For example, the receiver UE 605 may perform one or more measurements or determine one or more channel conditions based at least in part on the reference signal, and may generate the CSI based at least in part on the performed measurements.

In some aspects, the receiver UE 605 may be configured to encode the CSI and SCI-2 in the PSSCH. For example, the CSI may be jointly encoded with the SCI-2 (e.g., such that bits of the CSI and bits of the SCI-2 are encoded in a single encoding operation). Alternatively, the CSI may be encoded separately from the SCI-2 (e.g., such that bits of the CSI and bits of the SCI-2 are encoded in separate encoding operations and then concatenated in the PSSCH). The CSI may be encoded in a new SCI-2 format indicated in SCI-1 such that a UE (e.g., the transmitter UE 610) that receives the SCI-1 can determine whether or not the CSI is multiplexed with the SCI-2. In some aspects, an indication of the encoding of the CSI and the SCI-2 may be indicated in SCI-1. For example, the SCI-1 may indicate a location in the SCI-2 where the CSI is encoded. In some aspects, the receiver UE 605 may be configured to encode (e.g., jointly encode) the CSI with other data transmitted in one or more resources of the PSSCH. In some aspects, the other data may be destined to another UE other than a UE to which the CSI is destined, as described below.

In some aspects, the receiver UE 605 may be configured to encode the CSI with a stage of SCI other than the SCI-1 and the SCI-2 (e.g., in order to prevent overloading of the SCI-2). For example, the receiver UE 605 may be configured to encode the CSI with SCI-3. In some aspects, an indication of the encoding of the CSI and the SCI-3 may be indicated in the SCI-2. For example, the SCI-2 may indicate a location in the SCI-3 where the CSI is encoded. In some aspects, the SCI-3 may have the same identifier (e.g., radio network temporary identifier (RNTI)) as the SCI-2. In some aspects, the SCI-3 may have a different identifier (e.g., RNTI) than the SCI-2. Encoding the CSI with the SCI-2, SCI-3, or other information transmitted in the PSSCH may enable the CSI to be transmitted using the one or more resources of the PSSCH.

As shown in connection with reference number 630, the receiver UE 605 may transmit, and the transmitter UE 610 may receive, the CSI. The CSI may be transmitted using one or more resources of the PSSCH. For example, the CSI may be transmitted using the SL-SCH of the PSSCH. In some aspects, the CSI may be determined and/or transmitted without MAC layer processing. As described above, transmitting the CSI to the transmitter UE 610 may include transmitting one or more periodic CSI reports (e.g., according to a reporting period) or transmitting one or more aperiodic CSI reports (e.g., based at least in part on receiving DCI).

As described above, the receiver UE 605 may receive, from a second transmitter UE 615, a second sidelink communication. The sidelink communication received from the transmitter UE 610 may be a first received PSSCH communication and the second sidelink communication received from the second transmitter UE 615 may be a second received PSSCH communication. In some aspects, the sidelink communication transmitted by the transmitter UE 610 and the second sidelink communication transmitted by the second transmitter UE 615 may be unicast transmissions. In some aspects, the receiver UE 605 may transmit the CSI to the transmitter UE 610 and/or the second transmitter UE 615 based at least in part on the first received PSSCH communication and the second received PSSCH communication. The transmission of the CSI to the transmitter UE 610 and the second transmitter UE 615 may be a groupcast transmission. The groupcast transmission may use one or more resources of the PSSCH that are different from the one or more resources of the PSSCH that are used for the unicast transmission. For example, the unicast transmission may use a first set of resources of the PSSCH and the groupcast transmission may use a second set of resources of the PSSCH.

In some cases, the data and the CSI may be multiplexed in a groupcast communication that is intended for multiple UEs, such as the groupcast communication intended for the transmitter UE 610 and the second transmitter UE 615. In some cases, the data may be intended for a first set of one or more UEs (e.g., the transmitter UE 610) and the CSI may be intended for a different set of one or more UEs (e.g., the second transmitter UE 615). The groupcast communication may be transmitted with an identifier such that the UE receiving the groupcast communication (e.g., the transmitter UE 610) may determine whether the data and/or the CSI is intended for that UE (e.g., the transmitter UE 610) or for the one or more other UEs (e.g., the second transmitter UE 615). However, when the data and the CSI are intended for different UEs (e.g., the data is intended for a first UE and the CSI is intended for a second UE), transmitting a single identifier in the groupcast communication may result in unnecessary processing by one or more UEs. For example, a UE may decode and/or obtain data in the groupcast communication even if the groupcast communication includes only CSI for the UE, and not data for the UE (e.g., because a groupcast identifier matches a corresponding groupcast identifier associated with the UE). Similarly, a UE may decode and/or obtain CSI in the groupcast communication even if the groupcast communication includes only data for the UE, and not CSI for the UE (e.g., because a groupcast identifier matches a corresponding groupcast identifier associated with the UE). This wastes processing resources, memory, and battery power of the UE.

In some aspects, the receiver UE 605 may transmit an indication (e.g., in SCI-2 or SCI-1) that indicates whether CSI is piggybacked with a PSSCH communication (e.g., PSSCH data) in the groupcast communication. The indication may be transmitted prior to the PSSCH communication. For example, if the indication indicates that the groupcast message does not include CSI, then the transmitter UE 610 may determine whether the groupcast identifier corresponds to the transmitter UE 610, and may decode the data accordingly. For example, if the groupcast identifier corresponds to the transmitter UE 610 (e.g., matches a groupcast identifier stored by and/or configured for the transmitter UE 610), then the transmitter UE 610 may decode the data. However, if the indication indicates that the groupcast message includes CSI (e.g., piggybacked with data), the transmitter UE 610 may need to determine whether the CSI, the PSSCH data, or both are actually intended for the transmitter UE 610.

In some aspects, the groupcast message may indicate whether the data and the CSI are intended for the same group of UEs, or whether the data and the CSI are intended for different groups of UEs. For example, the transmitter UE 610 may receive, in the groupcast message, a first identifier associated with the data (e.g., a groupcast data identifier) and a second identifier associated with the CSI (e.g., a groupcast CSI identifier). In some aspects, such as when the same identifiers are used for the data and the CSI or when the data and the CSI are intended for the same group of UEs, the transmitter UE 610 may obtain (e.g., decode) both the data and the CSI based at least in part on determining that at least one of the identifiers corresponds to the transmitter UE 610. In some aspects, such as when different identifiers are used for the data as compared to the CSI or when the data and the CSI are intended for different groups of UEs, the transmitter UE 610 may obtain the data (and not the CSI) based at least in part on determining that the first identifier corresponds to the transmitter UE 610, and may obtain the CSI (and not the data) based at least in part on determining that the second identifier corresponds to the transmitter UE 610. For example, the transmitter UE 610 may obtain only the data based at least in part on determining that only the first identifier corresponds to the transmitter UE 610, may obtain only the CSI based at least in part on determining that only the second identifier corresponds to the transmitter UE 610, may obtain both the data and the CSI based at least in part on determining that both the first identifier and the second identifier correspond to the transmitter UE 610, or may obtain neither the data nor the CSI based at least in part on determining that neither the first identifier nor the second identifier correspond to the transmitter UE 610.

In some aspects, the receiver UE 605 may transmit, to the transmitter UE 610, a flag that indicates whether the identifier associated with the CSI is the same identifier, or a different identifier, than the identifier associated with the other data being transmitted in the PSSCH. The flag may be transmitted with the CSI, or may be transmitted separately from the CSI (e.g., in a separate communication). For example, a first state of the flag may indicate that the identifier associated with the CSI is the same identifier as the identifier associated with the other data being transmitted in the PSSCH, and a second state of the flag may indicate that the identifier associated with the CSI is a different identifier than the identifier associated with the other data being transmitted in the PSSCH. In some aspects, the flag may be one or more bits included in the PSSCH communication, or in a separate sidelink communication.

As shown in connection with reference number 635, the transmitter UE 610 may transmit, and the receiver UE 605 may receive, a NACK. The NACK may be one or more bits transmitted via the PSFCH and may indicate that the transmitter UE 610 did not receive a communication. In this case, the NACK may indicate that the transmitter UE 610 did not receive the CSI using the one or more resources of the PSSCH. In some aspects, the PSFCH resource used for the NACK message may be based at least in part on a destination identifier associated with the CSI. For example, the PSFCH resource used for the NACK message may be based at least in part on an identifier associated with the transmitter UE 610.

In some aspects, the PSFCH resources used for transmission of ACK/NACK messages corresponding to CSI reporting may be different from the PSFCH resources used for transmission of ACK/NACK messages corresponding to data. For example, if a UE receives a groupcast message with both data and CSI intended for the UE, the UE may use a first PSFCH resource for transmission of an ACK/NACK message for the data, and may use a second PSFCH resource for transmission of an ACK/NACK message for the CSI. The UE may use its identifier (e.g., a destination identifier) to identify the first resource and the second resource, and the destination identifier may map to different PSFCH resources for data ACK/NACKs as compared to CSI ACK/NACKs.

As shown in connection with reference number 640, the receiver UE 605 may retransmit the CSI. The receiver UE 605 may retransmit the CSI to the transmitter UE 610 based at least in part on receiving the NACK (e.g., on the second PSFCH resource, as described above). If the receiver UE 605 receives a NACK for the CSI and a NACK for the data, then the receiver UE 605 may retransmit both the CSI and the data. If the receiver UE 605 receives a NACK for the CSI and an ACK for the data, then the receiver UE 605 may retransmit the CSI without retransmitting the data. The receiver UE 605 may retransmit the CSI using one or more resources of the PSSCH, such as the same frequency and/or spatial resources used for the initial transmission of the CSI, or one or more other resources of the PSSCH.

In some aspects, the receiver UE 605 may determine whether the NACK corresponds to the CSI or to data transmitted in the PSSCH (e.g., PSSCH data, such as data carried in one or more transport blocks). For example, the receiver UE 605, based at least in part on determining that the NACK corresponds to the data, may retransmit the data using one or more resources of the PSSCH. Alternatively, the receiver UE 605, based at least in part on determining that the NACK corresponds to the CSI, may retransmit the CSI using the one or more resources of the PSSCH. Additionally, or alternatively, the receiver UE 605 may determine whether to retransmit the CSI or the data transmitted in the PSSCH based at least in part on an ACK. For example, the receiver UE 605, based at least in part on determining that the ACK corresponds to the data, may determine not to retransmit the data. Alternatively, the receiver UE 605, based at least in part on determining that the ACK corresponds to the CSI, may determine not to retransmit the CSI.

As described above, transmitting the CSI using a MAC-CE may result in delayed communications, for example, since the transmission of the CSI using the MAC-CE is a L2 communication. In contrast, transmitting the CSI using the PSFCH may result in faster communications, since the transmission of the CSI using the PSFCH is a L1 communication. However, transmissions using the PSFCH may not be as reliable as transmissions using the MAC-CE, and may require a larger resource allocation than the resource allocation provided by the PSFCH. The techniques and apparatuses described herein enable the CSI to be transmitted in one or more resources of the PSSCH, such as in the SL-SCH of the PSSCH. Transmitting the CSI in the one or more resources of the PSSCH may enable faster transmissions of the CSI, while providing improved reliability and a larger resource allocation.

As indicated above, FIG. 6 is provided as an example. Other examples may differ from what is described with respect to FIG. 6.

FIG. 7 is a diagram illustrating an example process 700 performed, for example, by a receiver UE, in accordance with the present disclosure. Example process 700 is an example where the receiver UE (e.g., receiver UE [ELEMENT REF]) performs operations associated with piggybacking channel state information on sidelink shared channel.

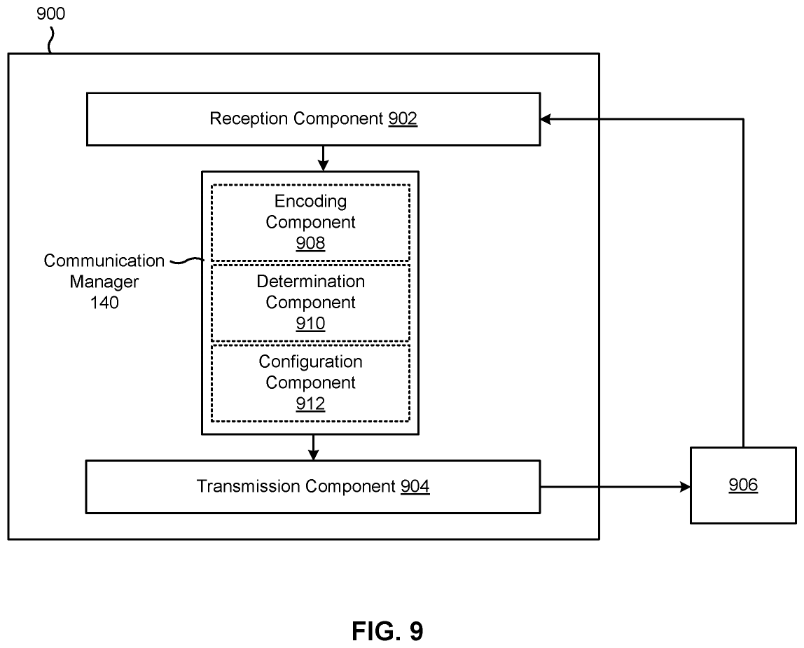

As shown in FIG. 7, in some aspects, process 700 may include receiving, from a transmitter UE, a sidelink communication (block 710). For example, the receiver UE (e.g., using communication manager 140 and/or reception component 902, depicted in FIG. 9) may receive, from a transmitter UE, a sidelink communication, as described above.

As further shown in FIG. 7, in some aspects, process 700 may include transmitting, to the transmitter UE, based at least in part on receiving the sidelink communication, channel state information (CSI) using one or more resources of a physical sidelink shared channel (PSSCH) (block 720). For example, the receiver UE (e.g., using communication manager 140 and/or transmission component 904, depicted in FIG. 9) may transmit, to the transmitter UE, based at least in part on receiving the sidelink communication, channel state information (CSI) using one or more resources of a physical sidelink shared channel (PSSCH), as described above.

Process 700 may include additional aspects, such as any single aspect or any combination of aspects described below and/or in connection with one or more other processes described elsewhere herein.

In a first aspect, the one or more resources of the PSSCH include a sidelink shared channel (SL-SCH) of the PSSCH.

In a second aspect, alone or in combination with the first aspect, the CSI is generated based at least in part on a reference signal associated with a PSSCH communication or a CSI reference signal.

In a third aspect, alone or in combination with one or more of the first and second aspects, process 700 includes encoding the CSI and a second stage sidelink control information (SCI-2) in the PSSCH.

In a fourth aspect, alone or in combination with one or more of the first through third aspects, the CSI is jointly encoded with the SCI-2.

In a fifth aspect, alone or in combination with one or more of the first through fourth aspects, the CSI is encoded separately from the SCI-2.

In a sixth aspect, alone or in combination with one or more of the first through fifth aspects, an indication of the encoding of the CSI and the SCI-2 is indicated in a first stage SCI (SCI-1).

In a seventh aspect, alone or in combination with one or more of the first through sixth aspects, process 700 includes jointly encoding the CSI with other data transmitted in the one or more resources of the PSSCH.

In an eighth aspect, alone or in combination with one or more of the first through seventh aspects, process 700 includes encoding the CSI with a stage of SCI other than a first stage SCI or a second stage SCI.

In a ninth aspect, alone or in combination with one or more of the first through eighth aspects, an indication of the CSI encoded with the stage of the SCI is indicated in the second stage SCI.

In a tenth aspect, alone or in combination with one or more of the first through ninth aspects, the sidelink communication is a first sidelink communication, and wherein the method further comprises receiving, from a second transmitter UE, a second sidelink communication, wherein the sidelink communication is a first received PSSCH communication and the second sidelink communication is a second received PSSCH communication, and transmitting, to the transmitter UE and the second transmitter UE, CSI using the PSSCH, wherein the CSI is based at least in part on the first received PSSCH communication and the second received PSSCH communication.

In an eleventh aspect, alone or in combination with one or more of the first through tenth aspects, the first sidelink communication and the second sidelink communication are unicast communications, and the transmission to the transmitter UE and the second transmitter UE, using the PSSCH, is a groupcast transmission.

In a twelfth aspect, alone or in combination with one or more of the first through eleventh aspects, process 700 includes transmitting, to at least one of the transmitter UE or the second transmitter UE, SCI indicating whether or not the CSI will be transmitted using the one or more resources of the PSSCH.

In a thirteenth aspect, alone or in combination with one or more of the first through twelfth aspects, the SCI is second stage SCI (SCI-2).

In a fourteenth aspect, alone or in combination with one or more of the first through thirteenth aspects, the CSI is directed to the transmitter UE and to one or more other UEs.

In a fifteenth aspect, alone or in combination with one or more of the first through fourteenth aspects, process 700 includes transmitting, using second stage SCI (SCI-2), one or more identifiers associated with the one or more other UEs.

In a sixteenth aspect, alone or in combination with one or more of the first through fifteenth aspects, the one or more identifiers includes a group identifier associated with the one or more other UEs.

In a seventeenth aspect, alone or in combination with one or more of the first through sixteenth aspects, process 700 includes transmitting the group identifier to the one or more UEs prior to transmitting the CSI.

In an eighteenth aspect, alone or in combination with one or more of the first through seventeenth aspects, transmitting the CSI comprises transmitting a flag that indicates whether the same identifiers are used for both the CSI and data, or whether different identifiers are used for the CSI as compared to the identifiers used for data.

In a nineteenth aspect, alone or in combination with one or more of the first through eighteenth aspects, process 700 includes receiving, from the transmitter UE, a negative acknowledgement (NACK) message indicating that the transmitter UE did not receive the CSI using the one or more resources of the PSSCH, and retransmitting, to the transmitter UE, the CSI using the one or more resources of the PSSCH.

In a twentieth aspect, alone or in combination with one or more of the first through nineteenth aspects, a physical sidelink feedback channel (PSFCH) resource used for the NACK message is based at least in part on a destination identifier associated with the CSI.

In a twenty-first aspect, alone or in combination with one or more of the first through twentieth aspects, the CSI is aperiodic CSI.

In a twenty-second aspect, alone or in combination with one or more of the first through twenty-first aspects, process 700 includes determining the CSI at a physical layer of the receiver UE.

In a twenty-third aspect, alone or in combination with one or more of the first through twenty-second aspects, the CSI is transmitted without medium access control (MAC) layer processing.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a transmitter user equipment (UE), in accordance with the present disclosure. Example process 800 is an example where the UE (e.g., UE 120) performs operations associated with piggybacking channel state information on sidelink shared channel.

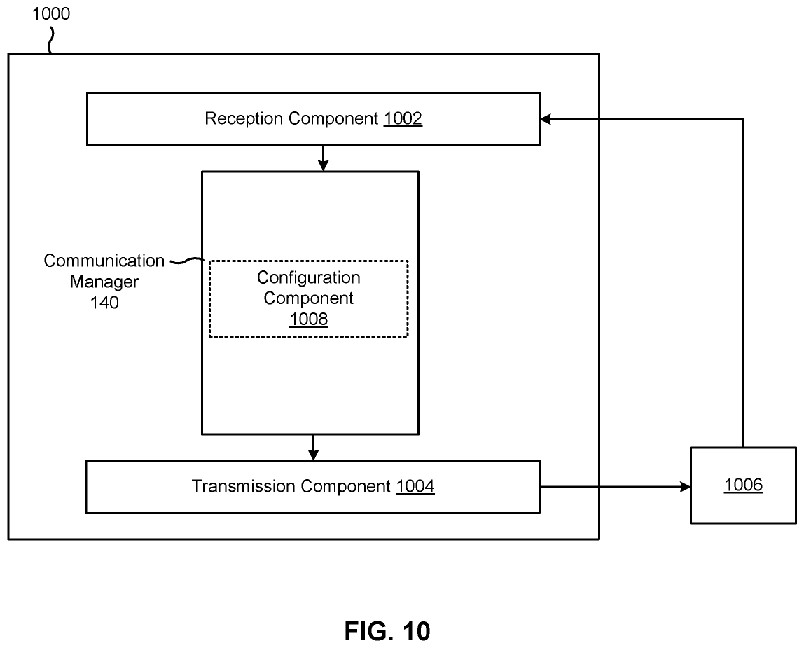

As shown in FIG. 8, in some aspects, process 800 may include transmitting, to a receiver UE, a sidelink communication (block 810). For example, the UE (e.g., using communication manager 140 and/or transmission component 1004, depicted in FIG. 10) may transmit, to a receiver UE, a sidelink communication, as described above.

As further shown in FIG. 8, in some aspects, process 800 may include receiving, from the receiver UE, based at least in part on transmitting the sidelink communication, channel state information (CSI) using one or more resources of a physical sidelink shared channel (PSSCH) (block 820). For example, the UE (e.g., using communication manager 140 and/or reception component 1002, depicted in FIG. 10) may receive, from the receiver UE, based at least in part on transmitting the sidelink communication, channel state information (CSI) using one or more resources of a physical sidelink shared channel (PSSCH), as described above.

Process 800 may include additional aspects, such as any single aspect or any combination of aspects described below and/or in connection with one or more other processes described elsewhere herein.

In a first aspect, the one or more resources of the PSSCH include a sidelink shared channel (SL-SCH) of the PSSCH.

In a second aspect, alone or in combination with the first aspect, the CSI is generated based at least in part on a reference signal associated with a PSSCH communication or a CSI reference signal.

In a third aspect, alone or in combination with one or more of the first and second aspects, the CSI and a second stage sidelink control information (SCI-2) are encoded in the PSSCH.

In a fourth aspect, alone or in combination with one or more of the first through third aspects, the CSI is jointly encoded with the SCI-2.

In a fifth aspect, alone or in combination with one or more of the first through fourth aspects, the CSI is encoded separately from the SCI-2.

In a sixth aspect, alone or in combination with one or more of the first through fifth aspects, an indication of the encoding of the CSI and the SCI-2 is indicated in a first stage SCI (SCI-1).

In a seventh aspect, alone or in combination with one or more of the first through sixth aspects, the CSI is jointly encoded with other data transmitted in the one or more resources of the PSSCH.

In an eighth aspect, alone or in combination with one or more of the first through seventh aspects, the CSI is encoded with a stage of SCI other than a first stage SCI or a second stage SCI.

In a ninth aspect, alone or in combination with one or more of the first through eighth aspects, an indication of the CSI encoded with the stage of the SCI is indicated in the second stage SCI.

In a tenth aspect, alone or in combination with one or more of the first through ninth aspects, process 800 includes receiving a flag that indicates whether the same identifiers are used for both the CSI and data, or whether different identifiers are used for the CSI as compared to the identifiers used for data.

In an eleventh aspect, alone or in combination with one or more of the first through tenth aspects, process 800 includes transmitting, to the receiver UE, a negative acknowledgement (NACK) message indicating that the transmitter UE did not receive the CSI using the one or more resources of the PSSCH.

In a twelfth aspect, alone or in combination with one or more of the first through eleventh aspects, a physical sidelink feedback channel (PSFCH) resource used for the NACK message is based at least in part on a destination identifier associated with the CSI.

In a thirteenth aspect, alone or in combination with one or more of the first through twelfth aspects, the CSI is aperiodic CSI.

In a fourteenth aspect, alone or in combination with one or more of the first through thirteenth aspects, the CSI is transmitted without medium access control (MAC) layer processing.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a receiver UE, or a receiver UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of an encoding component 908, a determination component 910, or a configuration component 912, among other examples.

In some aspects, the apparatus 900 may be configured to perform one or more operations described herein in connection with FIGS. 3-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the receiver UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the receiver UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the receiver UE described in connection with FIG. 2. In some aspects, the transmission component 904 may be co-located with the reception component 902 in a transceiver.

The reception component 902 may receive, from a transmitter UE, a sidelink communication. The transmission component 904 may transmit, to the transmitter UE, based at least in part on receiving the sidelink communication, channel state information (CSI) using one or more resources of a physical sidelink shared channel (PSSCH).

The encoding component 908 may encode the CSI and a second stage sidelink control information (SCI-2) in the PSSCH.

The encoding component 908 may jointly encode the CSI with other data transmitted in the one or more resources of the PSSCH.

The encoding component 908 may encode the CSI with a stage of SCI other than a first stage SCI or a second stage SCI.

The transmission component 904 may transmit, to at least one of the transmitter UE or the second transmitter UE, SCI indicating whether or not the CSI will be transmitted using the one or more resources of the PSSCH.

The transmission component 904 may transmit, using second stage SCI (SCI-2), one or more identifiers associated with the one or more other UEs.

The transmission component 904 may transmit the group identifier to the one or more UEs prior to transmitting the CSI.

The reception component 902 may receive, from the transmitter UE, a negative acknowledgement (NACK) message indicating that the transmitter UE did not receive the CSI using the one or more resources of the PSSCH.

The transmission component 904 may retransmit, to the transmitter UE, the CSI using the one or more resources of the PSSCH.

The determination component 910 may determine the CSI at a physical layer of the receiver UE.

The configuration component 912 may transmit or receive configuration information, such as information associated with one or more transport channels (e.g., the PSSCH), or the like

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a transmitter UE, or a transmitter UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a configuration component 1008, among other examples.

In some aspects, the apparatus 1000 may be configured to perform one or more operations described herein in connection with FIGS. 3-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the transmitter UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the transmitter UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the transmitter UE described in connection with FIG. 2. In some aspects, the transmission component 1004 may be co-located with the reception component 1002 in a transceiver.

The transmission component 1004 may transmit, to a receiver UE, a sidelink communication. The reception component 1002 may receive, from the receiver UE, based at least in part on transmitting the sidelink communication, channel state information (CSI) using one or more resources of a physical sidelink shared channel (PSSCH).

The reception component 1002 may receive a flag that indicates whether the same identifiers are used for both the CSI and data, or whether different identifiers are used for the CSI as compared to the identifiers used for data.

The transmission component 1004 may transmit, to the receiver UE, a negative acknowledgement (NACK) message indicating that the transmitter UE did not receive the CSI using the one or more resources of the PSSCH.

The configuration component 1008 may transmit or receive configuration information, such as information associated with one or more transport channels (e.g., the PSSCH), or the like.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a receiver user equipment (UE), comprising: receiving, from a transmitter UE, a sidelink communication; and transmitting, to the transmitter UE, based at least in part on receiving the sidelink communication, channel state information (CSI) using one or more resources of a physical sidelink shared channel (PSSCH).

Aspect 2: The method of Aspect 1, wherein the one or more resources of the PSSCH include a sidelink shared channel (SL-SCH) of the PSSCH.

Aspect 3: The method of any of Aspects 1-2, wherein the CSI is generated based at least in part on a reference signal associated with a PSSCH communication or a CSI reference signal.

Aspect 4: The method of any of Aspects 1-3, further comprising encoding the CSI and a second stage sidelink control information (SCI-2) in the PSSCH.

Aspect 5: The method of Aspect 4, wherein the CSI is jointly encoded with the SCI-2.

Aspect 6: The method of Aspect 4, wherein the CSI is encoded separately from the SCI-2.

Aspect 7: The method of Aspect 4, wherein an indication of the encoding of the CSI and the SCI-2 is indicated in a first stage SCI (SCI-1).

Aspect 8: The method of any of Aspects 1-7, further comprising jointly encoding the CSI with other data transmitted in the one or more resources of the PSSCH.

Aspect 9: The method of any of Aspects 1-8, further comprising encoding the CSI with a stage of SCI other than a first stage SCI or a second stage SCI.

Aspect 10: The method of Aspect 9, wherein an indication of the CSI encoded with the stage of the SCI is indicated in the second stage SCI.

Aspect 11: The method of any of Aspects 1-10, wherein the sidelink communication is a first sidelink communication, and wherein the method further comprises: receiving, from a second transmitter UE, a second sidelink communication, wherein the sidelink communication is a first received PSSCH communication and the second sidelink communication is a second received PSSCH communication; and transmitting, to the transmitter UE and the second transmitter UE, CSI using the PSSCH, wherein the CSI is based at least in part on the first received PSSCH communication and the second received PSSCH communication.

Aspect 12: The method of Aspect 11, wherein the first sidelink communication and the second sidelink communication are unicast communications, and the transmission to the transmitter UE and the second transmitter UE, using the PSSCH, is a groupcast transmission.

Aspect 13: The method of Aspect 11, further comprising transmitting, to at least one of the transmitter UE or the second transmitter UE, SCI indicating whether or not the CSI will be transmitted using the one or more resources of the PSSCH.

Aspect 14: The method of Aspect 13, wherein the SCI is second stage SCI (SCI-2).

Aspect 15: The method of any of Aspects 1-14, wherein the CSI is directed to the transmitter UE and to one or more other UEs.

Aspect 16: The method of Aspect 15, further comprising transmitting, using second stage SCI (SCI-2), one or more identifiers associated with the one or more other UEs.

Aspect 17: The method of Aspect 16, wherein the one or more identifiers includes a group identifier associated with the one or more other UEs.

Aspect 18: The method of Aspect 17, further comprising transmitting the group identifier to the one or more UEs prior to transmitting the CSI.

Aspect 19: The method of any of Aspects 1-18, wherein transmitting the CSI comprises transmitting a flag that indicates whether the same identifiers are used for both the CSI and data, or whether different identifiers are used for the CSI as compared to the identifiers used for data.

Aspect 20: The method of any of Aspects 1-19, further comprising: receiving, from the transmitter UE, a negative acknowledgement (NACK) message indicating that the transmitter UE did not receive the CSI using the one or more resources of the PSSCH; and retransmitting, to the transmitter UE, the CSI using the one or more resources of the PSSCH.

Aspect 21: The method of Aspect 20, wherein a physical sidelink feedback channel (PSFCH) resource used for the NACK message is based at least in part on a destination identifier associated with the CSI.

Aspect 22: The method of any of Aspects 1-21, wherein the CSI is aperiodic CSI.

Aspect 23: The method of any of Aspects 1-22, further comprising determining the CSI at a physical layer of the receiver UE.

Aspect 24: The method of any of Aspects 1-23, wherein the CSI is transmitted without medium access control (MAC) layer processing.

Aspect 25: A method of wireless communication performed by a transmitter user equipment (UE), comprising: transmitting, to a receiver UE, a sidelink communication; and receiving, from the receiver UE, based at least in part on transmitting the sidelink communication, channel state information (CSI) using one or more resources of a physical sidelink shared channel (PSSCH).

Aspect 26: The method of Aspect 25, wherein the one or more resources of the PSSCH include a sidelink shared channel (SL-SCH) of the PSSCH.

Aspect 27: The method of any of Aspects 25-26, wherein the CSI is generated based at least in part on a reference signal associated with a PSSCH communication or a CSI reference signal.

Aspect 28: The method of any of Aspects 25-27, wherein the CSI and a second stage sidelink control information (SCI-2) are encoded in the PSSCH.

Aspect 29: The method of Aspect 28, wherein the CSI is jointly encoded with the SCI-2.

Aspect 30: The method of Aspect 28, wherein the CSI is encoded separately from the SCI-2.

Aspect 31: The method of Aspect 28, wherein an indication of the encoding of the CSI and the SCI-2 is indicated in a first stage SCI (SCI-1).

Aspect 32: The method of any of Aspects 25-31, wherein the CSI is jointly encoded with other data transmitted in the one or more resources of the PSSCH.

Aspect 33: The method of any of Aspects 25-32, wherein the CSI is encoded with a stage of SCI other than a first stage SCI or a second stage SCI.

Aspect 34: The method of Aspect 33, wherein an indication of the CSI encoded with the stage of the SCI is indicated in the second stage SCI.

Aspect 35: The method of any of Aspects 25-34, further comprising receiving a flag that indicates whether the same identifiers are used for both the CSI and data, or whether different identifiers are used for the CSI as compared to the identifiers used for data.

Aspect 36: The method of any of Aspects 25-35, further comprising transmitting, to the receiver UE, a negative acknowledgement (NACK) message indicating that the transmitter UE did not receive the CSI using the one or more resources of the PSSCH.

Aspect 37: The method of Aspect 36, wherein a physical sidelink feedback channel (PSFCH) resource used for the NACK message is based at least in part on a destination identifier associated with the CSI.

Aspect 38: The method of any of Aspects 25-37, wherein the CSI is aperiodic CSI.

Aspect 39: The method of any of Aspects 25-38, wherein the CSI is transmitted without medium access control (MAC) layer processing.

Aspect 40: An apparatus for wireless communication at a device, comprising a processor; memory coupled with the processor; and instructions stored in the memory and executable by the processor to cause the apparatus to perform the method of one or more of Aspects 1-24.

Aspect 41: A device for wireless communication, comprising a memory and one or more processors coupled to the memory, the one or more processors configured to perform the method of one or more of Aspects 1-24.

Aspect 42: An apparatus for wireless communication, comprising at least one means for performing the method of one or more of Aspects 1-24.

Aspect 43: A non-transitory computer-readable medium storing code for wireless communication, the code comprising instructions executable by a processor to perform the method of one or more of Aspects 1-24.

Aspect 44: A non-transitory computer-readable medium storing a set of instructions for wireless communication, the set of instructions comprising one or more instructions that, when executed by one or more processors of a device, cause the device to perform the method of one or more of Aspects 25-39.

Aspect 45: An apparatus for wireless communication at a device, comprising a processor; memory coupled with the processor; and instructions stored in the memory and executable by the processor to cause the apparatus to perform the method of one or more of Aspects 25-39.

Aspect 46: A device for wireless communication, comprising a memory and one or more processors coupled to the memory, the one or more processors configured to perform the method of one or more of Aspects 25-39.

Aspect 47: An apparatus for wireless communication, comprising at least one means for performing the method of one or more of Aspects 25-39.

Aspect 48: A non-transitory computer-readable medium storing code for wireless communication, the code comprising instructions executable by a processor to perform the method of one or more of Aspects 25-39.

Aspect 49: A non-transitory computer-readable medium storing a set of instructions for wireless communication, the set of instructions comprising one or more instructions that, when executed by one or more processors of a device, cause the device to perform the method of one or more of Aspects 25-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a receiver user equipment (UE), comprising:
a memory; and
one or more processors, coupled to the memory, configured to:
receive, from a transmitter UE, a sidelink communication; and
transmit, to the transmitter UE, based at least in part on receiving the sidelink communication, channel state information (CSI) using one or more resources of a physical sidelink shared channel (PSSCH).

2. The apparatus of claim 1, wherein the one or more resources of the PSSCH include a sidelink shared channel (SL-SCH) of the PSSCH.

3. The apparatus of claim 1, wherein the CSI is generated based at least in part on a reference signal associated with a PSSCH communication or a CSI reference signal.

4. The apparatus of claim 1, wherein the one or more processors are further configured to encode the CSI and a second stage sidelink control information (SCI-2) in the PSSCH.

5. The apparatus of claim 4, wherein an indication of the encoding of the CSI and the SCI-2 is indicated in a first stage SCI (SCI-1).

6. The apparatus of claim 1, wherein the one or more processors are further configured to jointly encode the CSI with other data transmitted in the one or more resources of the PSSCH.

7. The apparatus of claim 1, wherein the one or more processors are further configured to encode the CSI with a stage of SCI other than a first stage SCI or a second stage SCI.

8. The apparatus of claim 7, wherein an indication of the CSI encoded with the stage of the SCI is indicated in the second stage SCI.

9. The apparatus of claim 1, wherein the CSI is directed to the transmitter UE and to one or more other UEs.

10. The apparatus of claim 9, wherein the one or more processors are further configured to transmit, using second stage SCI (SCI-2), one or more identifiers associated with the one or more other UEs.

11. The apparatus of claim 1, wherein the one or more processors, to transmit the CSI, are configured to transmit a flag that indicates whether the same identifiers are used for both the CSI and data, or whether different identifiers are used for the CSI as compared to the identifiers used for data.

12. The apparatus of claim 1, wherein the one or more processors are further configured to:
receive, from the transmitter UE, a negative acknowledgement (NACK) message indicating that the transmitter UE did not receive the CSI using the one or more resources of the PSSCH; and
retransmit, to the transmitter UE, the CSI using the one or more resources of the PSSCH.

13. An apparatus for wireless communication at a transmitter user equipment (UE), comprising:
a memory; and
one or more processors, coupled to the memory, configured to:
transmit, to a receiver UE, a sidelink communication; and
receive, from the receiver UE, based at least in part on transmitting the sidelink communication, channel state information (CSI) using one or more resources of a physical sidelink shared channel (PSSCH).

14. The apparatus of claim 13, wherein the one or more resources of the PSSCH include a sidelink shared channel (SL-SCH) of the PSSCH.

15. The apparatus of claim 13, wherein the CSI is generated based at least in part on a reference signal associated with a PSSCH communication or a CSI reference signal.

16. The apparatus of claim 13, wherein the CSI and a second stage sidelink control information (SCI-2) are encoded in the PSSCH.

17. The apparatus of claim 16, wherein an indication of the encoding of the CSI and the SCI-2 is indicated in a first stage SCI (SCI-1).

18. The apparatus of claim 13, wherein the CSI is jointly encoded with other data transmitted in the one or more resources of the PSSCH.

19. The apparatus of claim 13, wherein the CSI is encoded with a stage of SCI other than a first stage SCI or a second stage SCI.

20. The apparatus of claim 19, wherein an indication of the CSI encoded with the stage of the SCI is indicated in the second stage SCI.

21. The apparatus of claim 13, wherein the one or more processors are further configured to receive a flag that indicates whether the same identifiers are used for both the CSI and data, or whether different identifiers are used for the CSI as compared to the identifiers used for data.

22. The apparatus of claim 13, wherein the one or more processors are further configured to transmit, to the receiver UE, a negative acknowledgement (NACK) message indicating that the transmitter UE did not receive the CSI using the one or more resources of the PSSCH.

23. A method of wireless communication performed by a receiver user equipment (UE), comprising:
receiving, from a transmitter UE, a sidelink communication; and
transmitting, to the transmitter UE, based at least in part on receiving the sidelink communication, channel state information (CSI) using one or more resources of a physical sidelink shared channel (PSSCH).

24. The method of claim 23, wherein the one or more resources of the PSSCH include a sidelink shared channel (SL-SCH) of the PSSCH.

25. The method of claim 23, wherein the CSI is generated based at least in part on a reference signal associated with a PSSCH communication or a CSI reference signal.

26. The method of claim 23, further comprising encoding the CSI and a second stage sidelink control information (SCI-2) in the PSSCH.

27. A method of wireless communication performed by a transmitter user equipment (UE), comprising:
transmitting, to a receiver UE, a sidelink communication; and
receiving, from the receiver UE, based at least in part on transmitting the sidelink communication, channel state information (CSI) using one or more resources of a physical sidelink shared channel (PSSCH).

28. The method of claim 27, wherein the one or more resources of the PSSCH include a sidelink shared channel (SL-SCH) of the PSSCH.

29. The method of claim 27, wherein the CSI is generated based at least in part on a reference signal associated with a PSSCH communication or a CSI reference signal.

30. The method of claim 27, wherein the CSI and a second stage sidelink control information (SCI-2) are encoded in the PSSCH.
